(19) United States
(12) Patent Application Publication
(10) Pub. No.: US 2004/0174426 A1
(43) Pub. Date: Sep. 9, 2004

(54) Image forming apparatus

(75) Inventors: Yujiro Nomura, Nagano-ken (JP); Yoshiro Koga, Nagano-ken (JP)

Correspondence Address: SUGHRUE MION, PLLC, 2100 Pennsylvania Avenue, NWW, Washington, DC, 20037-3213, US

(73) Assignee: SEIKO EPSON CORPORATION

(21) Appl. No.: 10/326,919

(22) Filed: Dec. 23, 2002

(30) Foreign Application Priority Data
Dec. 25, 2001 (JP) 2001-391158
Jan. 16, 2002 (JP) 2002-007236
Jan. 16, 2002 (JP) 2002-007237
Jan. 16, 2002 (JP) 2002-007238

(51) Int. Cl. B41J 2/45

(52) U.S. Cl. 347/238; 347/240

(57) ABSTRACT

The object of the present invention is to realize a micro image forming apparatus by employing an organic EL array as a writing head thereof. The image forming apparatus comprises: at least one image forming station Y, M, C, K having an image carrier 46 and further having a charging means 47, an exposure means 1, a developing means 48, and a transfer means 45 which are arranged around the image carrier 46; wherein a toner image formed by the image forming station is transferred to a transfer medium. An organic EL array exposure head 1 is provided as the exposure means 1 and the transfer medium is an intermediate transfer belt 42. The image forming apparatus further comprises a fixing means 58 for fixing the toner image on a receiving medium P which is secondarily transferred from the intermediate transfer belt. The intermediate transfer belt 42 is located between the organic EL array exposure head 1 and the fixing means 58.

### BACKGROUND OF THE INVENTION

The present invention relates to an image forming apparatus which has a reduced size by employing an organic electroluminescence (EL) array exposure head.

In conventional image forming apparatus, such as copying machines, printers, and facsimile machines, utilizing electrophotographic technology, it is common practice to employ a laser scanning optical system as writing means.

Under such circumstances, an image forming apparatus employing a light emitting diode (LED) array as writing means has been proposed in Japanese Patent Unexamined Publication No. H2-273258.

Further, an image forming apparatus employing a one-chip light emitting element comprising an organic EL array has been proposed in Japanese Patent Unexamined Publication No. H11-198433.

In Japanese Patent Unexamined Publication No. 2000-127489, an image forming apparatus employing an organic EL head as writing means has been proposed in which a temperature sensor and a heater are provided inside an element array of the head for keeping the temperature constant.

Since a conventional laser-driven image forming apparatus requires a laser scanning optical system, the writing head thereof should be large so that it is difficult to achieve a reduction in size of the apparatus. Further, in case of a full color image forming apparatus of a tandem type, it is difficult to improve the positioning accuracy of four scanning beams so that there is a problem of causing error of registration and thus deteriorating the image quality.

On the other hand, in the LED-driven image forming apparatus, the LED array is composed of a plurality of LED chips linked to each other linearly and the LED chips differ in luminescent characteristic from one chip to another, thus producing linear stains in an output image. Even though the LED array has an advantage over the laser scanning optical system in positioning accuracy of pixels, the relative positioning accuracy at linked portion between elements is reduced, thereby causing color registration error.

Normally, a driver circuit is arranged near the light emitting elements to reduce the number of electric wiring between a main body and the head. Since the LED has a difficulty in forming its emitting part and the driving circuit on a single substrate, it is required to arrange the driver ICs next to the elements so that the width of the array of the elements is increased for driver ICs. Therefore, in case of employing a small-sized OPC (organic semiconductor) drum, it is difficult to arrange the LED array between a charging device and a deploying device, disturbing reduction in size of the apparatus.

In Japanese Patent Unexamined Publication No. H11-198433 in which the organic EL array is employed as the writing means of the image forming apparatus, its light emitting part and its driving part can be formed on a single substrate so that there is an advantage over the LED array in positioning accuracy of elements and the elements can have reduced width. However, there is a problem that the elements are susceptible to ambient moisture and thus deteriorated so that its emitting amount and its emitting efficiency are reduced. Especially in case of image forming apparatus, the elements are deteriorated by hot air with high humidity generated from the fixing device.

In Japanese Patent Unexamined Publication No. 2000-127489 in which the temperature sensor and the heater are provided inside an element array of the head for keeping the temperature constant, the element array should be complex and large because of existence of the temperature sensor and the heater. Similarly to the LED array, it is difficult to employ a small-sized photoreceptor.

### SUMMARY OF THE INVENTION

The present invention was made to overcome the aforementioned problems of conventional image forming apparatuses and the object of the present invention is to provide a micro image forming apparatus by employing an organic EL array as a writing head thereof.

An image forming apparatus of a first aspect of the present invention achieving the aforementioned object comprises at least one image forming station having an image carrier and further having a charging means, an exposure means, a developing means, and a transfer means which are arranged around said image carrier, wherein a toner image formed by said image forming station is transferred to a transfer medium. In this image forming apparatus, said exposure means comprises an organic EL array exposure head; said transfer medium is an intermediate transfer belt or a receiving medium carried by a sheet delivery belt; said image forming apparatus further comprises a fixing means for fixing the toner image on a receiving medium secondarily transferred from said intermediate transfer belt or fixing the toner image on the receiving medium separated from said sheet delivery belt; and said intermediate transfer belt or said sheet delivery belt is located between said organic EL array exposure head and said fixing means.

According to the image forming apparatus of the first aspect of the present invention, the intermediate transfer belt or the sheet delivery belt is located between the organic EL array exposure head and the fixing means. By heating a receiving medium (paper sheet) at the fixing means, the moisture contained in the paper sheet is vaporized to produce hot air with high humidity. However, the hot air with high humidity is blocked by the intermediate transfer belt or the sheet delivery belt, thereby preventing the deterioration of organic EL emitters of the organic EL array exposure head due to the moisture generated at the fixing unit.

An image forming apparatus of a second aspect of the present invention comprises at least one image forming station having an image carrier and further having a charging means, an exposure means, a developing means, and a transfer means which are arranged around said image carrier, wherein a toner image formed by said image forming station is transferred to a transfer medium. In this image forming apparatus, said exposure means comprises an organic EL array exposure head; and at least one heat source in the apparatus is located at a position lower than said organic EL array exposure head.

According to the image forming apparatus of the second aspect of the present invention, the organic EL array exposure head is provided as the exposure means and at least one heat source of the apparatus is located at a position lower than the organic EL array exposure head. The organic EL array exposure head is heated by the heat source so as to reduce the relative humidity around the exposure heads, thereby preventing the deterioration of organic EL emitters of the organic EL array exposure head due to the moisture. In addition, the increase in temperature of organic EL emitters because of the heat source increases the emitting efficiency of the exposure head.

An image forming apparatus of a third aspect of the present invention comprises at least one image forming station having an image carrier and further having a charging means, an exposure means, a developing means, and a transfer means which are arranged around said image carrier, wherein a toner image formed by said image forming station is transferred to a transfer medium. In the image forming apparatus, said exposure means comprises an organic EL array exposure head; and at least one heat source in the apparatus is located at a rear side of said organic EL array exposure head opposite to a side where said transfer means is located.

According to the image forming apparatus of the third aspect of the present invention, the organic EL array exposure head is provided as the exposure means and at least one heat source of the apparatus is located at a rear side of the organic EL array exposure head opposite to a side where said transfer means is located, thereby preventing variation in deterioration of the exposure head, preventing unevenness in the emitting efficiency, and preventing the registration error and unevenness of colors.

An image forming apparatus of a fourth aspect of the present invention achieving the aforementioned object comprises at least one image forming station having an image carrier and further having a charging means, an exposure means, a developing means, and a transfer means which are arranged around said image carrier, wherein a toner image formed by said image forming station is transferred to a transfer medium. In this image forming apparatus, said exposure means comprises an organic EL array exposure head; and at least one heat source in the apparatus is located at a position higher than said organic EL array exposure head.

According to the image forming apparatus of the fourth aspect of the present invention, the organic EL array exposure head is provided as the exposure means and at least one heat source of the apparatus is located at a position higher than the organic EL array exposure head so that the organic EL array exposure head can be prevented from being heated by the heat source, thereby preventing variation in deterioration of the exposure head, preventing unevenness in the emitting efficiency, and preventing the registration error and unevenness of colors.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a schematic sectional view showing entire structure of an image forming apparatus of an embodiment according to the present invention;

FIG. 2 is a schematic plan view showing an embodiment of organic EL array exposure head to be used in the present invention;

FIG. 3 is a sectional view showing one pixel in the array taken along a line of A-A in FIG. 2;

FIG. 4 is a side view showing the focusing state of the organic EL array exposure head;

FIG. 5 is a pixel driver circuit for current programming gradation control of the organic EL array exposure head;

FIG. 6 is an illustration for operational principle of the current programming gradation control of the FIG. 5;

FIG. 7 is a schematic sectional view showing entire structure of an image forming apparatus of another embodiment according to the present invention;

FIG. 8 is a schematic sectional view showing entire structure of an image forming apparatus of another embodiment according to the present invention;

FIG. 9 is a schematic sectional view showing entire structure of an embodiment for explaining arrangements for replacing paper sheets, replacing consumables, and positioning exposure heads in the image forming apparatus of the present invention;

FIG. 10 is an enlarged view of a transfer belt unit and an image forming unit shown in FIG. 9;

FIG. 11 is an illustration for explaining the state of replacing a sheet cassette in the apparatus shown in FIG. 9;

FIG. 12 is an illustration for explaining the state of exposing the transfer belt unit by pivotally moving a closure member in the apparatus shown in FIG. 9;

FIG. 13 is an illustration for explaining the state of replacing developing means after the step shown in FIG. 12;

FIG. 14 is an illustration for explaining the state of replacing the transfer belt unit and an image carrier unit after the step shown in FIG. 12;

FIG. 15 is an illustration showing an example of a mechanism for positioning an organic EL array exposure head relative to an image carrier;

FIG. 16 is a schematic sectional view showing entire structure of another embodiment of the image forming apparatus according to the present invention;

FIG. 17 is a schematic sectional view showing entire structure of another embodiment of the image forming apparatus-according to the present invention;

FIG. 18 is a schematic sectional view showing entire structure of another embodiment of the image forming apparatus according to the present invention;

FIG. 19 is a schematic sectional view showing entire structure of another embodiment of the image forming apparatus according to the present invention;

FIG. 20 is a schematic sectional view showing entire structure of another embodiment of the image forming apparatus according to the present invention;

FIG. 21 is a schematic sectional view showing entire structure of another embodiment of the image forming apparatus according to the present invention;

FIG. 22 is a schematic sectional view showing entire structure of another embodiment of the image forming apparatus according to the present invention;

FIG. 23 is a schematic sectional view showing entire structure of another embodiment of the image forming apparatus according to the present invention;

FIG. 24 is a schematic sectional view showing entire structure of another embodiment of the image forming apparatus according to the present invention;

FIG. 25 is a schematic sectional view showing entire structure of another embodiment of the image forming apparatus according to the present invention; and

FIG. 26 is a schematic sectional view showing entire structure of another embodiment of the image forming apparatus according to the present invention.

### DESCRIPTION OF THE PREFERRED EMBODIMENTS

An image forming apparatus utilizing electrophotographic technology comprises image carriers (photoreceptors), and charging means, exposure means, developing means and transferring means which are arranged around the image carriers, and fixing means for fixing toner images transferred to a receiving medium (paper sheet).

Employing an organic EL elements (head) as exposure means (writing means) in such an image forming apparatus utilizing the electrophotographic technology has a problem that the organic EL elements are deteriorated by moisture. There is also a problem that increase in temperature affects the durability of the organic EL elements. However, the increase in temperature contrarily provides a merit of increasing the emitting efficiency of the organic EL elements.

According to the present invention, the problem that the organic EL elements are deteriorated by moisture is solved by placing the organic EL head apart from a fixing device as a source of moisture. In addition, by heating an area surrounding the organic EL head to reduce relative humidity around the organic EL head, the emitting efficiency can be increased as well as solving the problem.

If necessary, it is designed to prevent the temperature of the area surrounding the organic EL head from rising.

By employing the organic EL head as the exposure means in addition to the aforementioned means for solving the problem, the reduction in size of the image forming apparatus is achieved.

Hereinafter, the image forming apparatus of the present invention will be described with reference to embodiments.

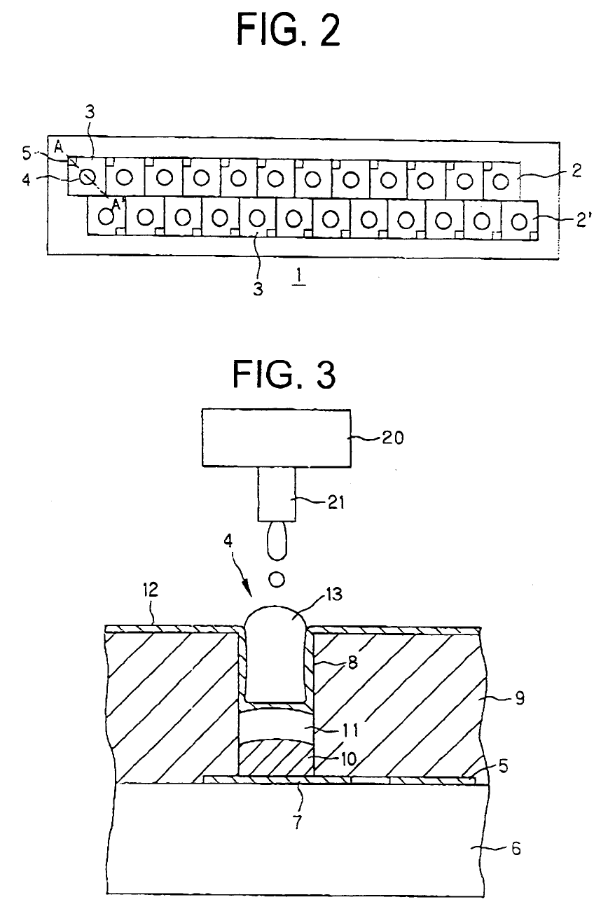

FIG. 2 is a schematic plan view of an embodiment of the organic EL array exposure head to be used in the present invention and FIG. 3 is a sectional view showing one pixel in the array taken along a line of A-A′ in FIG. 2.

The organic EL array exposure head 1 of this embodiment has two arrays 2, 2′ parallel to each other such that pixels which are in different arrays are arranged in a zigzag fashion. Each array 2, 2′ comprises a plurality of pixels 3 aligned linearly. These pixels 3 are same in structure and each comprises an organic EL emitter 4 and a TFT (thin-film transistor) 5 for controlling the emission of light of the organic EL emitter 4.

FIG. 3 is a sectional view showing one pixel 3 including the organic EL emitter 4 and the TFT 5. The pixel will be described in its preparing order. First, a TFT 5 is made on a glass substrate 6. There are various methods of making the TFT 5. For example, silicone oxide is first deposited into a layer on the glass substrate 6 and amorphous silicon is then deposited into a layer thereon. Excimer laser beam is exposed to the amorphous silicon layer to crystallize to form a polysilicon layer as a channel. After patterning the polysilicon layer, a gate insulating layer is formed and further a gate electrode is formed of tantalum nitride. Subsequently, source/drain regions for N-channel TFT are formed by ion implantation of phosphorous and source/drain regions for P-channel TFT are formed by ion implantation of boron. After impurities of ion implantation is activated, a first layer insulating film is formed, first contact holes are formed, source lines are formed, a second layer insulating film is formed, second contact holes are formed and metallic pixel electrodes are formed, thereby completing the array of TFT 5 (for example, see “Polymer Organic EL Display” presented at the 8th Electronic Display Forum (Apr. 18, 2001)). The metallic pixel electrode is made of metal such as Mg, Ag, Al, and Li and functions as a cathode 7 for the organic EL emitter 4 and also as a reflection layer for the organic EL emitter 4.

Then, a bank 9 of a predetermined height is formed to have a hole 8 receiving the organic EL emitter 4. The bank 9 may be formed by any suitable method such as a photolithographic technique, a printing technique, and so on as disclosed in Japanese Patent Unexamined Publication No. 2000-353594. In case of using the photolithographic technique, an organic material is applied by a suitable method such as a spin coating method, a spray coating method, a roll coating method, a die coating method, and a dip coating method to have height corresponding to the height of the bank 9, and a resist layer is formed thereon. Parts of the resist layer corresponding to the shape of the bank 9 are coated with masking. The resist layer is exposed and developed, thus leaving the parts of the resist layer corresponding to the configuration of the bank 9. Finally, the organic material is etched, thereby removing parts of the organic material not coated with the masking. The bank may be formed of two layers of which the lower layer is made of inorganic material and the upper layer is made of organic material. As disclosed in Japanese Patent Unexamined Publication No. 2000-323276, the material of the bank 9 is any material having resistance against the solvent for the EL material and there is no other special limitation on selection of the material. However, organic materials such as acrylic resin, epoxy resin, and photosensitive polyimide are preferable because these can be treated by fluorocarbon gas plasma treatment to have Teflon-like characteristics. The bank may be a laminated bank having a lower layer made of inorganic material such as liquid glass. It is preferable to mix carbon black into the aforementioned material to have black or opaque bank.

Immediately before applying ink composition as a material of emitting layer of the organic EL, the substrate with the bank 9 is treated by continuity of oxygen gas plasma and fluorocarbon gas plasma. By this treatment, the polyimide surface of the bank 9 is changed to have water repellency and the surface of the cathode 7 is changed to have hydrophilicity. In addition, the wettability of the substrate required for finely patterning inkjet drops can be controlled. The device for producing plasma used for this treatment may be a device which produces plasma in vacuo or a device which produces plasma in the atmosphere.

An ink composition as a material of emitting layer is discharged into the hole 8 of the bank 9 from a head 21 of an inkjet printer 20, thereby achieving the patterning application on the cathode 7 of the pixel. After the application, the solvent is removed and the applied ink composition is treated by heat, thereby forming an emitting layer 10.

It should be noted that the inkjet printer used in the present invention may be of a type using a piezoelectric method in which ink composition is pushed out by mechanical energy of a piezoelectric element or the like or of a type using a thermal method in which ink composition is heated to form bubbles by utilizing thermal energy of a heater so that the ink composition is forced out according the generation of bubbles (see “Fine Imaging and Hardcopy” compiled by the publishing committee composed of The Society of Photographic Science and Technology of Japan and The Imaging Society of Japan and issued at Jan. 7, 1999 (Corona Publishing Co. Ltd., p.43).

After forming the emitting layer 10 within the hole 8, an ink composition as a material of hole injection layer is discharged onto the emitting layer 10 within the hole 8 from the head 21 of the inkjet printer 20, thereby achieving the patterning application on the emitting layer 10 of the pixel. After the application, the solvent is removed and the applied ink composition is treated by heat, thereby forming a hole injection layer 11.

The emitting layer 10 and the hole injection layer 11 may be formed upside down. It is preferable to form a layer having resistance against moisture on a surface side (a side apart from the substrate 6).

The emitting layer 10 and the hole injection layer 11 may be formed by other known method such as a spin coating method, a dipping method, and a vapor deposition method instead of applying ink compositions by ink-jet method as the above.

The material of the emitting layer 10 and the material of the hole injection layer 11 may be known materials listed in Japanese Patent Unexamined Publication H10-12377 and Japanese Patent Unexamined Publication 2000-323276, so description about details will be omitted.

After the emitting layer 10 and the hole injection layer 11 are individually formed in the hole 8 of the bank 9, the entire surface of the substrate is coated with a transparent electrode 12 by vacuum vapor deposition. The transparent electrode 12 functions as an anode of the organic EL. The material of the transparent electrode 12 may be selected from a group including a tin oxide film, an indium tin oxide (ITO) film, a combined oxide film of an indium oxide and zinc oxide. Instead of the vacuum vapor deposition, other techniques including the photolithography, the spattering method, and the metal fog method. By using such a technique, the transparent electrode 12 is formed over the top surface of the bank 9 and over the inner surface of the hole 8.

After the surface of the transparent electrode 12 is treated by water repellent finish, a transparent ink composition as a material of micro lens is discharged into the hole 8 of the bank 9 from the head 21 of the ink-jet printer 20, thereby achieving the patterning application. After the application, the composition is hardened, thereby forming a convex micro lens 13 on the organic EL emitter 4 of each pixel. The curvature radius of the top, i.e. the focal length, of the convex micro lens 13 depends on the discharged amount of the ink composition, the diameter of the hole 8, the surface tension of the transparent ink composition, the degree of water repellency relative to the transparent electrode 12, the percentage of contraction of the ink composition when hardened, and the like.

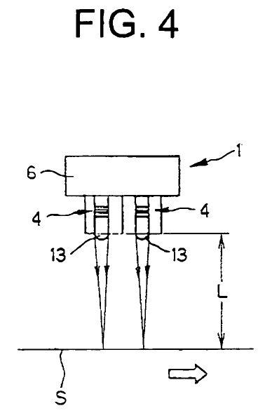

As described above, the arrays of organic EL emitters 4 are formed on the substrate 6 as well as the arrays of TFT 5 for controlling the emission of the respective organic EL emitters 4. Convex micro lenses 13 having a predetermined focal length are formed on the organic EL emitters 4, respectively by the inkjet method. The organic EL array exposure head 1 having the aforementioned structure of the embodiment of the present invention focuses the emitting beams from the respective organic EL emitters 4, having an array pattern coinciding with the pixels 3 of the organic EL array exposure head 1, onto a plane S which is spaced apart from the organic EL array exposure head 1 by a predetermined distance L as shown in a side view of FIG. 4. By moving the plane S relative to the organic EL array exposure head 1 in a direction perpendicular to the longitudinal direction of the organic EL array exposure head 1 and controlling the emission of the respective organic EL emitters 4 of the organic EL array exposure head 1 with the TFT 5, a desired pattern can be recorded on the plane S.

In the present invention, the organic EL array exposure array head 1 as described in the above embodiment is employed as an exposure head of an image forming apparatus utilizing electrophotographic technology. Before the description of embodiments of image forming apparatus employing such organic EL array exposure head 1, the method of driving the respective emitters 4 of the organic EL arrays will be described.

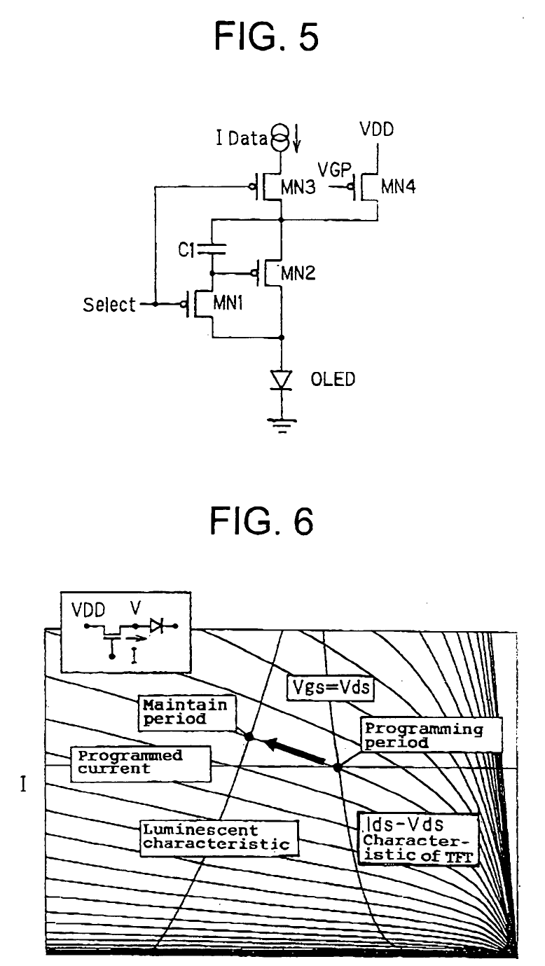

This driving methodology is called “current programming gradation control” and has been developed for light emitting polymer display (see “Light Emitting Polymer Display driven by Low-temperature poly-Si Thin Film Transistor” in “Liquid Crystal Display Technology 2001” as a separate volume of July issue of “DenshiZairyou” (July, 2001) by Kogyo Chosakai Publishing Co., Ltd.). By the current programming gradation control, variation in emitted light brightness due to variation in any characteristics can be restrained. The pixel driver circuit for the current programming gradation control is shown in FIG. 5. The operational principle of the current programming gradation control is shown in FIG. 6. In current programming period, the gate electrode and the drain electrode of the TFT are short-circuited so that Vgs=Vds is established, and a gradation control signal is supplied as an analog signal to the TFT. Vgs at this point is stored in a capacitor C1. In maintain period, analog current is' switched to a constant voltage VDD and operational point becomes a cross-over point for I-V characteristic of the TFT and the light emitting element OLED. Both in the current programming period and the maintain period, the TFT operates within its saturation region. Also in the maintain period, current is supplied in the same amount of the programmed current.

An advantage of the current programming gradation control is that it can restrict variation in emitted light brightness due to variation in characteristics such as of TFTs and light emitting elements. Another advantage is that it is not required to connect the corresponding number of constant current sources to light emitting portions so that only a single constant voltage source VDD connected to the light emitting portions is enough.

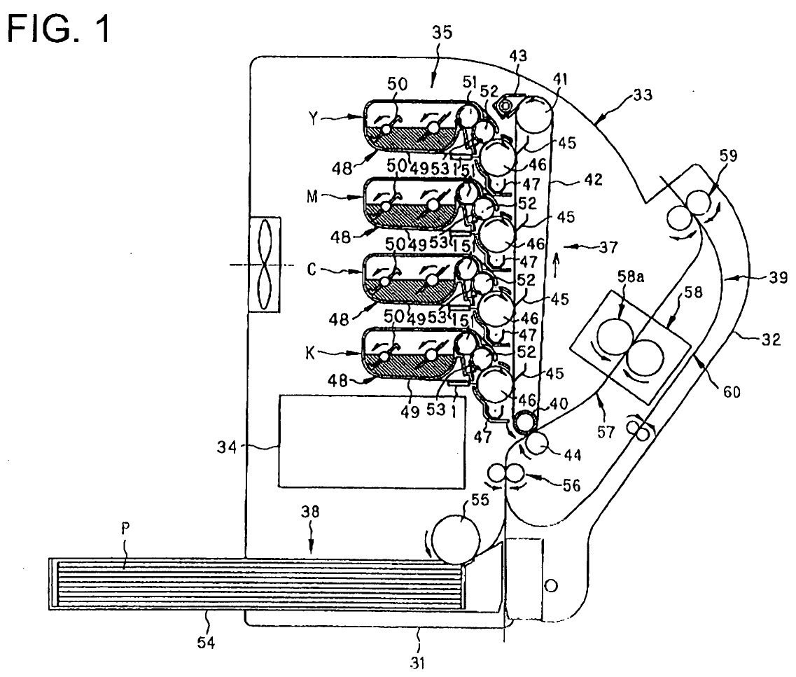

FIG. 1 is a schematic sectional view showing entire structure of an image forming apparatus of an embodiment according to the present invention. In FIG. 1, the image forming apparatus of this embodiment is a full color image forming apparatus employing the intermediate transfer method and a vertical tandem arrangement and comprises a housing body 31, a closure member (door body) 32 which is attached to the front of the housing body 31 in such a manner that the closure member is able to open or close freely, and an outfeed tray (outfeed portion) 33 formed in the top of the closure member 32. Arranged within the housing body 31 are an electrical substrate 34 for driving and controlling the image forming apparatus, an image forming unit 35, an air fan 36 for cooling, a transfer belt unit 37, and a sheet feeding unit 38. Arranged within the closure member 32 is a sheet handling means 39. The consumables of the image forming unit 35 and the sheet feeding unit 38 are designed to be detachable relative to the housing body. In this case, the components including the transfer belt unit 37 can be detached for the purpose of repair or replacement of consumables.

The transfer belt unit 37 comprises a driving roller 40 which is disposed in a lower portion of the housing body 31 and is driven by a driving means (not shown) to rotate, a tension roller 41 which is disposed above the driving roller 40, an intermediate transfer belt 42 which is laid around the two rollers with a certain tension and is driven to circulate in a direction indicated by an arrow (the counter-clockwise direction), and a cleaning means 43 which abuts on the surface of the intermediate transfer belt 42. The tension roller 41 and the intermediate transfer belt 42 are arranged above the driving roller 40.

The driving roller 40 also functions as a backup roller for a secondary transfer roller 44. The tension roller 41 also functions as a backup roller for the cleaning means 43.

On the back of the intermediate transfer belt 42, primary transfer members 45 composed of leaf spring electrodes are disposed. The primary transfer members 45 are pressed into contact with the back of the intermediate transfer belt 42 by their elastic force at locations corresponding to image carriers (photosensitive drum) 46 of respective image forming stations Y, M, C, and K.

The image forming unit 35 comprises a plurality (four in this embodiment) of image forming stations Y (for yellow), M (for magenta), C (for cyan), and K (for black) for forming images of different colors. Each image forming station Y, M, C, K has an image carrier 46 composed of a photosensitive drum, a charging means 47 composed of a corona charging means, an organic EL array exposure head 1 as exposure means (writing means) as described with reference to FIG. 2 through FIG. 4, and developing means 48 which are arranged around the image carrier 46 in an order from the upstream to the downstream in the rotational direction of the image carrier 46. It should be understood that the image forming stations Y, M, C, K may be arranged in any order.

The image forming stations Y, M, C, K are disposed such that the respective image carriers 46 are in contact with a belt face, of which traveling direction is downward, of the intermediate transfer belt 42. As a result of this, the image forming stations Y, M, C, K are arranged on the left side, as seen in FIG. 1, relative to the driving roller 40. Each image carrier 46 is driven to rotate in the traveling direction of the intermediate transfer belt 42 as indicated by arrows.

The developing means 48 each comprises the toner storage container 49 for storing toner (indicated by hatching), a toner agitating member 50 disposed inside the toner storage container 49, a toner supply roller 51, a development roller 52, and a regulating blade 53.

The sheet feeding unit 38 comprises a sheet cassette 54 in which a pile of receiving media P are held, and a pick-up roller 55 for feeding the receiving media P from the sheet cassette 54 one by one.

The sheet handling means 39 comprises a pair of resist rollers 56 for regulating the feeding of a receiving medium P to the secondary transfer portion at the right time, the secondary transfer roller 44 as a secondary transfer means abutting and pressed against the driving roller 40 and the intermediate transfer belt 42, a sheet feeding passage 57, the fixing unit 58, a pair of outfeed rollers 59, and a dual-side printing passage 60.

The fixing unit 58 comprises a pair of fixing rollers 58a at least one of which has a built-in heating element such as a halogen heater and which are freely rotatable, and a pressing means for pressing at least one of the rollers 58a against the other roller to press a secondary image secondarily transferred to the receiving medium P. The secondary image secondarily transferred to the receiving medium is fixed to the receiving medium at the nip portion formed between the fixing rollers 58a at a predetermined temperature.

In each of the image forming stations Y, M, C, K having the aforementioned structure, the developing means 48 uses, as an example, a non-magnetic single-component toner as the developer. Such a non-magnetic single-component toner stored in the toner storage container 49 is agitated by the agitating member 50 and supplied to the development roller 52 by the toner supply roller 51. The developer adhering to the surface of the development roller 52 is regulated by the regulating blade 53 into a layer of a predetermined thickness. The development roller 52 is brought in contact with or pressed against the image carrier 46, whereby the developer is attracted according to the potential level of the image carrier 46. An electrostatic latent image is formed on the image carrier 46 by exposing image parts of the image carrier to light of the exposure head 1 after uniformly charged by the charging means 47. The electrostatic latent image is developed to be a toner image by the developing means 48. Toner images for respective colors of yellow, magenta, cyan, and black formed on the image forming stations Y, M, C, K are primarily transferred by the primary transfer bias, applied to the primary transfer member 45, one by one to superpose each other on the intermediate transfer belt 42 so as to form a multi-color image. The multi-color image is secondarily transferred to a receiving medium P such as a paper sheet by the secondary transfer roller 44 and is fixed on the receiving medium P by passing between the pair of fixing rollers 58a of the fixing unit 58. The receiving medium P with the image is discharged to the outfeed tray 33 formed in the top of the apparatus by the outfeed rollers 59.

In this embodiment, the receiving medium (paper) P is heated by the fixing unit 58 so that moisture contained in the paper is vaporized, generating hot air with high humidity. Since the intermediate transfer belt 42 is located between the organic EL array exposure heads 1 and the fixing unit 58 as shown in FIG. 1, the hot air with high humidity is blocked by the intermediate transfer belt 42, thereby preventing the deterioration of the organic EL emitters of the organic EL array exposure heads 1 due to the moisture generated at the fixing unit 58.

Since the organic EL emitters 4 are formed on a single substrate 6 as described above with reference to FIG. 2-FIG. 3, the organic EL array exposure head 1 has improved positioning accuracy of pixels, thereby preventing registration error and unevenness of colors.

The organic EL emitters 4 and their driver circuits (TFTs) 5 can be easily formed on the common substrate 6, thereby achieving the reduction in size of the organic EL array exposure head 1 and thus achieving the reduction in size of the image forming apparatus.

The emitters 4 of the organic EL array exposure head 1 are preferably driven and controlled with constant current as described above with reference to FIG. 5-FIG. 6. As shown in FIG. 1, even though the affect of moisture is blocked by the intermediate transfer belt 42 located between the organic EL array exposure heads 1 and the fixing unit 58, a slant increase in temperature around the organic EL array exposure heads 1 is inevitable because of the heat from the fixing unit 58. Variation in temperature o the exposure head 1 varies the emitting efficiency and thus varies the emitting amount of the organic EL emitters 4. By driving the organic EL emitters 4 with constant current control, however, the emitting amount of the organic EL emitters 4 can be kept constant even with variation in temperature, thereby enabling the stable formation of images.

The intermediate transfer belt 42 is preferably made of a resin with low thermal conductivity such as polyester (thermal conductivity: 0.16 Wm⁻¹ K⁻¹), polyimide, PET, and polyurethane. When the intermediate transfer belt 42 is to located between the organic EL array exposure heads 1 and the fixing unit 58 as shown in FIG. 1, dropwise condensation occurs at a fixing unit side of the intermediate transfer belt 42 because the fixing unit 58 side is heated and the exposure unit 1 side is cooled. Therefore, there is a problem that water drops formed by the dropwise condensation are transferred to the image carriers 46 and thus carried to neighborhood of the exposure heads 1. The dropwise condensation stands out when the intermediate transfer belt 42 is a belt made of a metal having high thermal conductivity (10-200 Wm⁻¹ K⁻¹).

By employing a resin (0.5 Wm⁻¹ K⁻¹) as the material of the intermediate transfer belt 42, the thermal conductivity of the intermediate transfer belt 42 is lowered as compared to the case employing a metal as the material of the intermediate transfer belt 42. Therefore, the thermal responsibility of the surface of the image transfer belt 42 against the outside temperature is improved, thereby preventing the occurrence of dropwise condensation. In case using a sheet delivery belt and not conducting secondary transfer, a belt made of a resin having low thermal conductivity is also preferably used as the sheet delivery belt.

It is preferable to use a hygroscopic material such as polyester (percentage of absorption: 0.8% (according to ASTM570-63)) as the material of the intermediate transfer belt 42 or the sheet delivery belt. By using such a hygroscopic material (percentage of absorption: 0.5% or more) as the material of the transfer belt, even when dropwise condensation occurs at the intermediate transfer belt 42 or the sheet delivery belt, the moisture generated due to dropwise condensation is absorbed by the intermediate transfer belt 42 or the sheet delivery belt, thereby preventing adverse effect on the organic EL array exposure heads 1.

It is preferable to use a belt having emissivity (=absorptivity) of about 0.8 or more, preferably 0.9 or more, i.e. nearly 1, seeming to be a black body belt. To achieve this, carbon black is dispersed in the material such as a resin. The increase in emissivity of the intermediate transfer belt 42 or the sheet delivery belt increases the transmission of heat from the fixing unit 58 by radiation to the intermediate transfer belt 42 or the sheet delivery belt, thereby effectively heating the image transfer belt 42 or the sheet delivery belt. As a result, the temperature of the area surrounding the exposure heads 1 is increased. The increase in temperature of the area surrounding the exposure heads 1 reduces the relative humidity around the exposure heads 1, thereby preventing the deterioration of the exposure heads 1 and also increasing the emitting efficiency of the exposure heads 1.

The volume occupied by the intermediate transfer belt 42 or the sheet delivery belt in the form laid around the two rollers (the driving roller 40 and the tension roller 41) within the image forming apparatus can be minimized as shown in FIG. 1 so that it is preferable from the viewpoint of miniaturization of the apparatus.

Though the image forming apparatus shown in FIG. 1 is of a type using the intermediate transfer method, assuming that the apparatus is of a type using a sheet delivery belt as mentioned as the latter case, the sheet feeding passage must be complex because a paper sheet is introduced to the fixing unit after stripped from the sheet delivery belt. On the other hand, in the intermediate transfer method, the fixing unit 58 can be located at a position after the secondary transfer so that the sheet handling means 39 is advantageously simple.

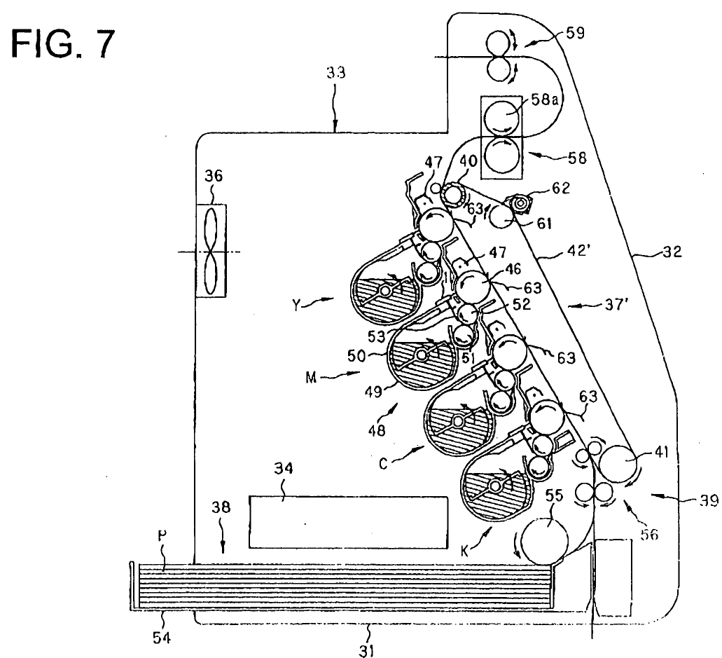

FIG. 7 is a schematic sectional view showing entire structure of another embodiment of the image forming apparatus according to the present invention. It should be noted that the same components as those of the embodiment of FIG. 1 are marked with the same numerals, so description of such components will be omitted. This embodiment is a full color image forming apparatus of an inclined tandem type employing a sheet delivery method using a sheet delivery belt as described in the above. In this embodiment, a sheet delivery belt 42′ is used instead of the intermediate transfer belt 42 in FIG. 1.

In this embodiment, a transfer unit 37′ and a sheet handling means 39 are arranged in the closure member 32. The transfer unit 37′ comprises a driving roller 40 which is disposed in an upper portion of a housing body 31 and is driven by a driving means (not shown) to rotate, a tension roller 41 and a backup roller 61 which are disposed diagonally below the driving roller 40, a sheet delivery belt 42′ which is laid around the three rollers with certain tension and is driven to circulate in a direction indicated by an arrow (the clockwise direction), and a cleaning means 62 which is in contact with the surface of the sheet delivery belt 42′ to oppose the back-up roller 61. The driving roller 40 and the sheet delivery belt 42′ are arranged obliquely to the upper left of the tension roller 41 as seen in FIG. 7. On the back of the sheet delivery belt 42′, transfer members 63 composed of leaf spring electrodes are disposed. The transfer members 63 are pressed into contact with the back of the sheet delivery belt 42′ by their elastic force at locations corresponding to image carriers 46 of respective image forming stations Y, M, C, and K.

Also in this embodiment, since the sheet delivery belt 42′ is located between the fixing unit 58, as an source of hot air with high humidity, and the organic EL array exposure heads 1, the hot air with high humidity is blocked by the sheet delivery belt 42′, thereby preventing the deterioration of the organic EL emitters of the organic EL array exposure heads 1 due to the moisture generated at the fixing unit 58.

In the embodiment of FIG. 7, further, the fixing unit 58 is located at a position higher than the organic EL array exposure heads 1 so that air, heated by the fixing unit 58 and thus absorbing moisture, moves upward. Accordingly, air having high moisture never moves to the neighborhood of the organic EL array exposure heads 1, thereby further securely preventing the deterioration of the organic EL emitters.

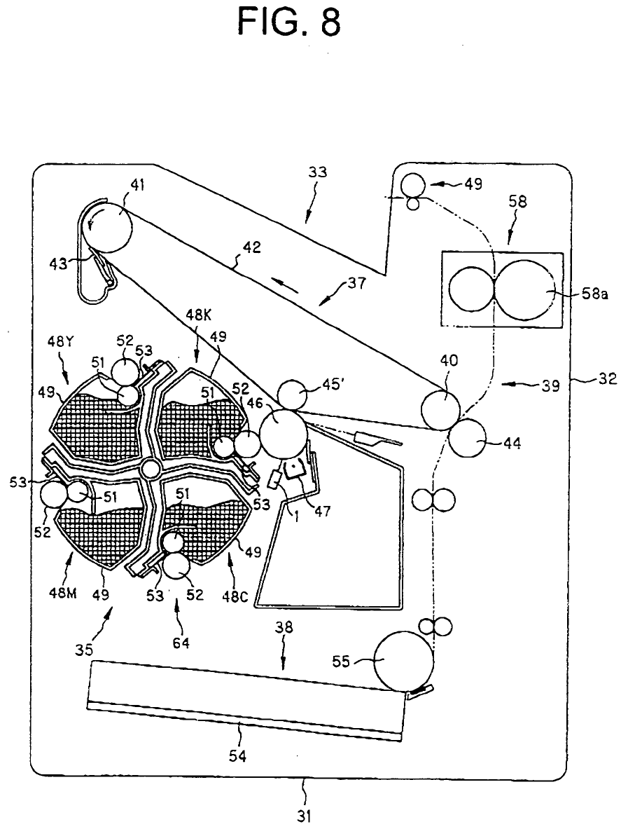

FIG. 8 is a schematic sectional view showing entire structure of another embodiment of the image forming apparatus according to the present invention. It should be noted that the same components as those of the embodiment of FIG. 1 are marked with the same numerals, so description of such components will be omitted.

In this embodiment, differently from the embodiment of FIG. 1 in which the image forming stations are arranged in tandem, a single image carrier (photosensitive drum) 46 is used and a charging means 47 composed of a single corona charging means, a single organic EL array exposure head 1 as an exposure means (writing means), a rotary developing device 64 are arranged around the image carrier 46 in an order from the upstream to the downstream in the rotational direction of the image carrier 46. The rotary developing device 64 has a developing unit 48Y for Y (yellow), a developing unit 48M for M (magenta), a developing unit 48C for C (cyan), and a developing unit 48K for K (for black) which are arranged about the rotation axis such a manner as to allow angular switching operation. An electrostatic latent image is formed on the image carrier 46 by exposing image parts of the image carrier to light of the exposure head 1 after uniformly charged by the charging means 47. The electrostatic latent image is developed into a toner image by one of the developing units 48Y, 48M, 48C, and 48K of the rotary developing device 64. Every developing unit 48Y, 48M, 48C, 48K is selected by rotation to form toner images of respective colors of yellow, magenta, cyan, and black. The toner images thus sequentially formed are primarily transferred to the intermediate transfer belt 42 by a primary transfer bias applied to a primary transfer member (transfer roller) 45′ so as to superpose each other on the intermediate transfer belt 42 so as to form a multi-color image. The multi-color image is secondarily transferred to a receiving medium P such as a paper sheet at a secondary transfer roller 44 and is fixed on the receiving medium P by passing between a pair of fixing rollers 58a of a fixing unit 58. The receiving medium P with the image is discharged to an outfeed tray 33 formed in the top of the apparatus by a pair of outfeed rollers 59.

Also in the image forming apparatus of this embodiment using the single image carrier 46, the single organic EL array exposure head 1, and the rotary developing device 64 having a plurality of developing units 48Y, 48M, 48C, 48K which are switchable, the receiving medium (paper) P is heated by the fixing unit 58 so that moisture contained in the paper is vaporized, generating hot air with high humidity. Since the intermediate transfer belt 42 is located between the organic EL array exposure head 1 and the fixing unit 58, similarly to the apparatus described with reference to FIG. 1, the hot air with high humidity is blocked by the intermediate transfer belt 42, thereby preventing the deterioration of the organic EL emitters of the organic EL array exposure head 1 due to the moisture generated at the fixing unit 58.

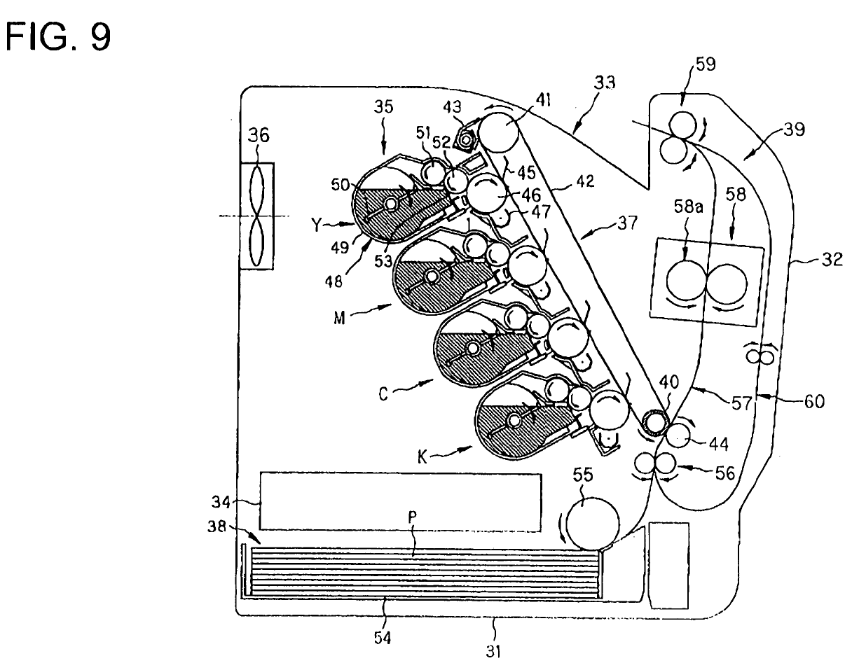

Now, description will now be made as regard to a specific example of arrangements for replacing paper sheets, replacing consumables, and positioning the exposure heads 1 in the color image forming apparatus similar to the apparatus shown in FIG. 1, with reference to FIG. 9-FIG. 15. It should be noted that the same components as those of the embodiment of FIG. 1 are marked with the same numerals, so description of such components will be omitted.

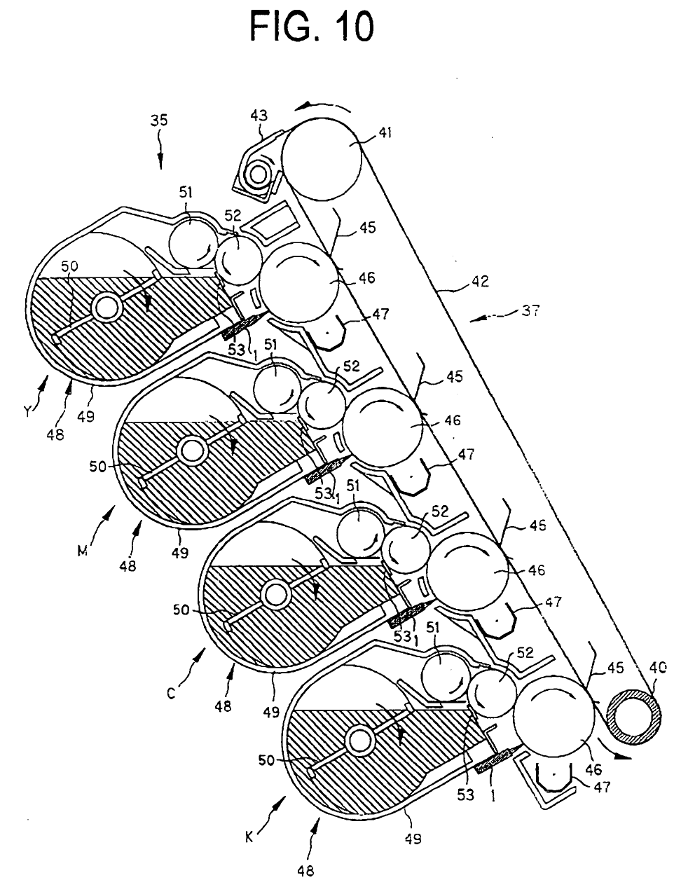

FIG. 9 is a schematic sectional view showing entire structure of the image forming apparatus of this embodiment and FIG. 10 is an enlarged view of a transfer belt unit 37 and an image forming unit 35 shown in FIG. 9. This embodiment has substantially the same structure of the embodiment of FIG. 1 except a point that image forming stations Y, M, C, K are obliquely arranged in tandem (these are vertically arranged in case of FIG. 1). Also in this embodiment, an intermediate transfer belt 42 is located between organic EL array exposure heads 1 and a fixing unit 58, thereby preventing the deterioration of organic EL emitters of the organic EL array exposure heads 1 due to the moisture generated at the fixing unit 58.

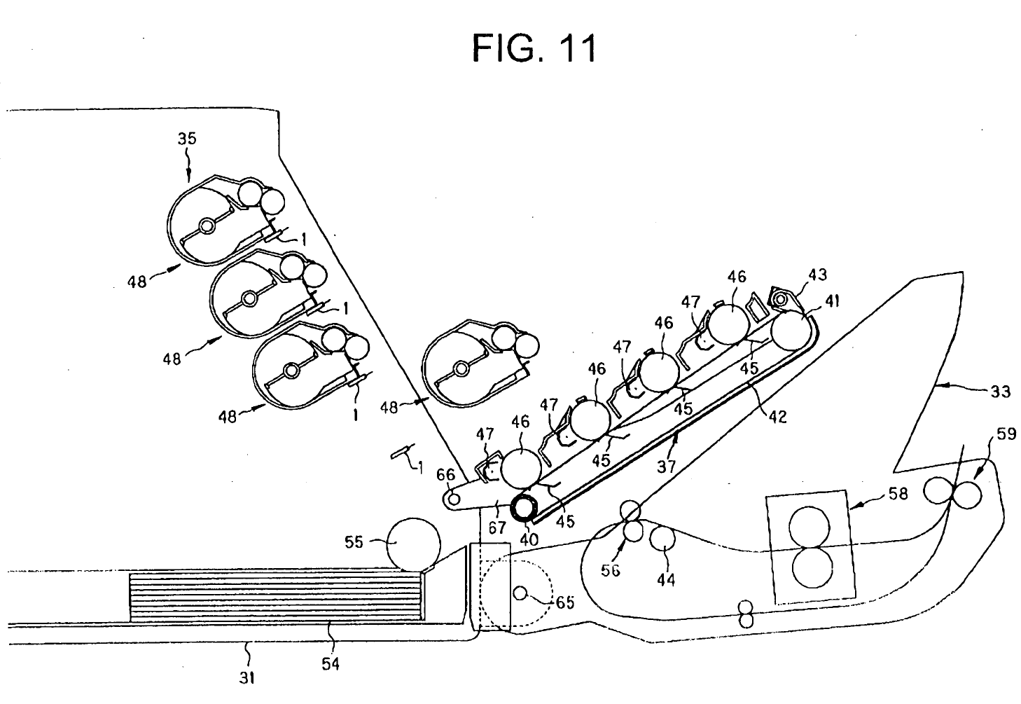

In the image forming apparatus having the aforementioned structure, a sheet cassette 54 in which a pile of receiving media P are held can be designed to be replaced only by operation in front of the housing body 31 (in the right side as seen in drawings) as shown in FIG. 11.

For replacing consumables in the image forming apparatus of this embodiment, from the state shown in FIG. 9, the closure member 32 is first rotated about a first pivot shaft 65 from the housing body 31 to the front and is thus folded forward together with the sheet handling means 39, the fixing unit 58, the secondary transfer roller 44, a pair of resist rollers 56, and a pair of outfeed rollers 59 which are arranged inside the closure member 32 as one unit. As a result, the transfer belt unit 37 in the housing body 31 is exposed outside.

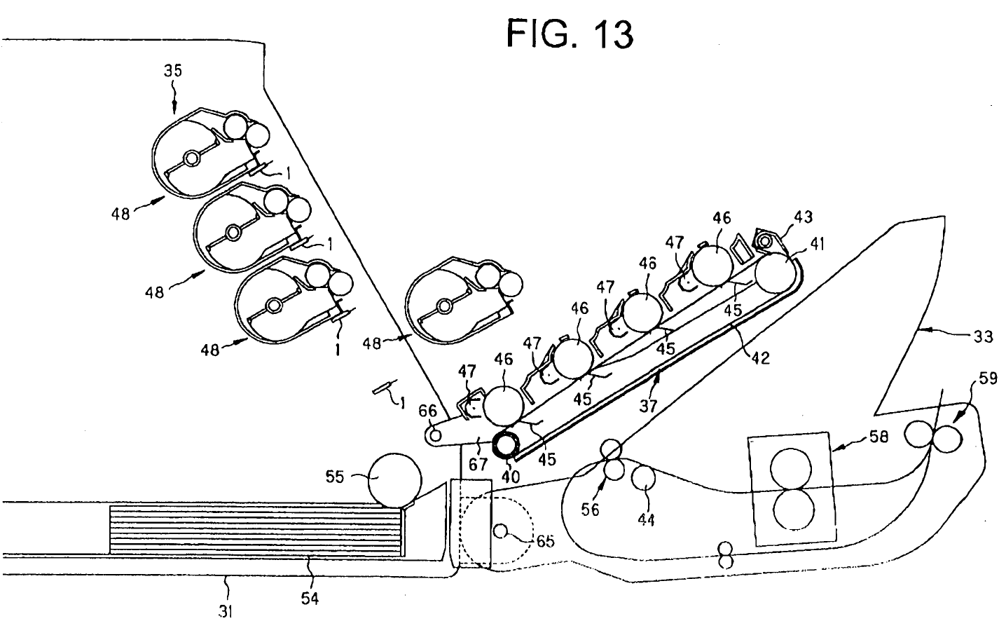

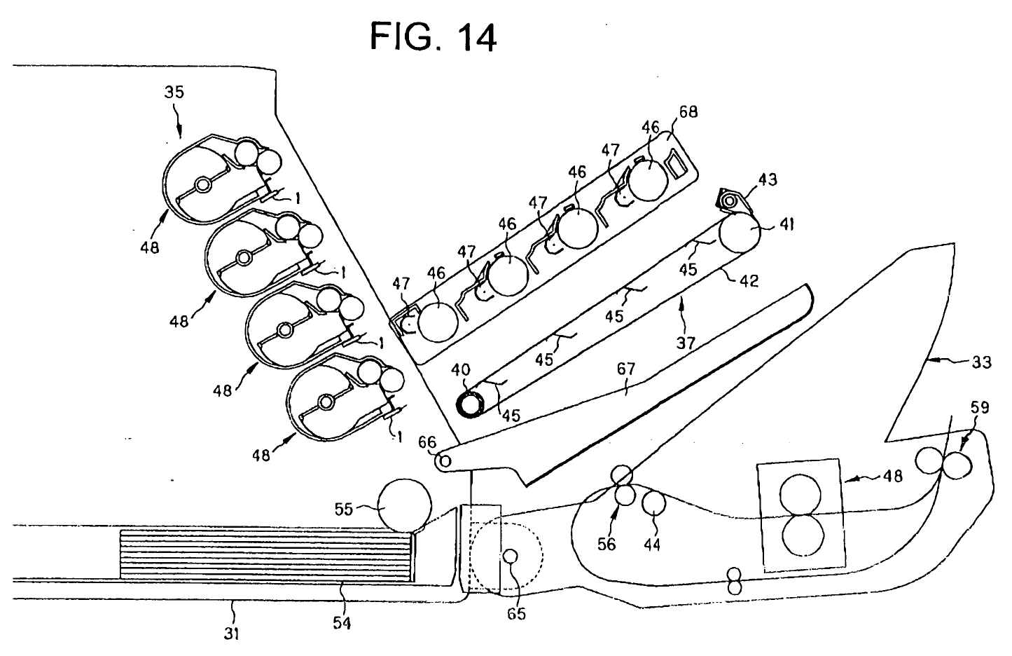

In this state, as shown in FIG. 13, a frame 67 supporting the transfer belt unit 37 and an image carrier unit 68 (see FIG. 14) is rotated about a second pivot shaft 66 from the housing body 31 to the front so as to expose the image forming unit 35 outside. For example, the developing means 48 for K to be replaced in the image forming unit 35 is detached and replaced with a new developing means 48. During this, the organic EL array exposure head 1 as the exposure means corresponding to the developing means 48 remains in the housing body 31 and is not replaced.

In the state that the frame 67 is folded forward, as shown in FIG. 14, the transfer belt unit 37 and the image carrier unit 68 can be detached from the frame 67 and replaced with new ones. In the image carrier unit 68, the respective image carriers (photosensitive drums) 46 and the respective charging means 47 of the image forming stations Y, M, C, K are attached together as one unit. In the state shown in FIG. 13, the image carrier unit 68 is separated from the respective image forming stations Y, M, C, K.

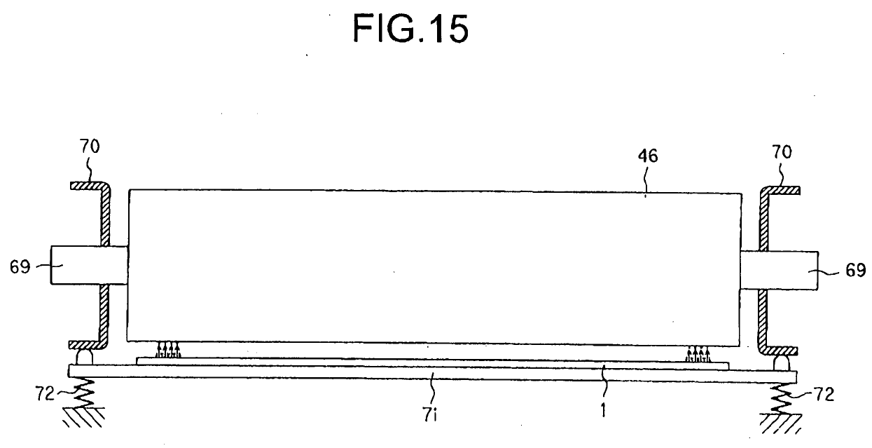

FIG. 15 shows an example of a mechanism for accurately positioning the organic EL array exposure heads 1 relative to the image carriers (photosensitive drums) 46 attached to the image carrier unit 68. The image carriers 46 are attached to a frame 70 of the image carrier unit 68 through a shaft 69 thereof so that the image carrier 46 can rotate. On the other hand, each organic EL array exposure head 1 is held by a long head holding member 71. The head holding member 71 is pressed against the frame 70 by expandable springs 72 located at both ends thereof. Therefore, the organic EL array exposure heads 1 can be accurately positioned relative to the frame 70, located at both sides of the image carriers 46. Under the condition that the image carriers 47 are accurately positioned relative to the frame 70, the exposure heads 1 can be accurately positioned relative to the image carriers 47, thereby improving the positioning accuracy of images and thus preventing the registration error and unevenness of colors.

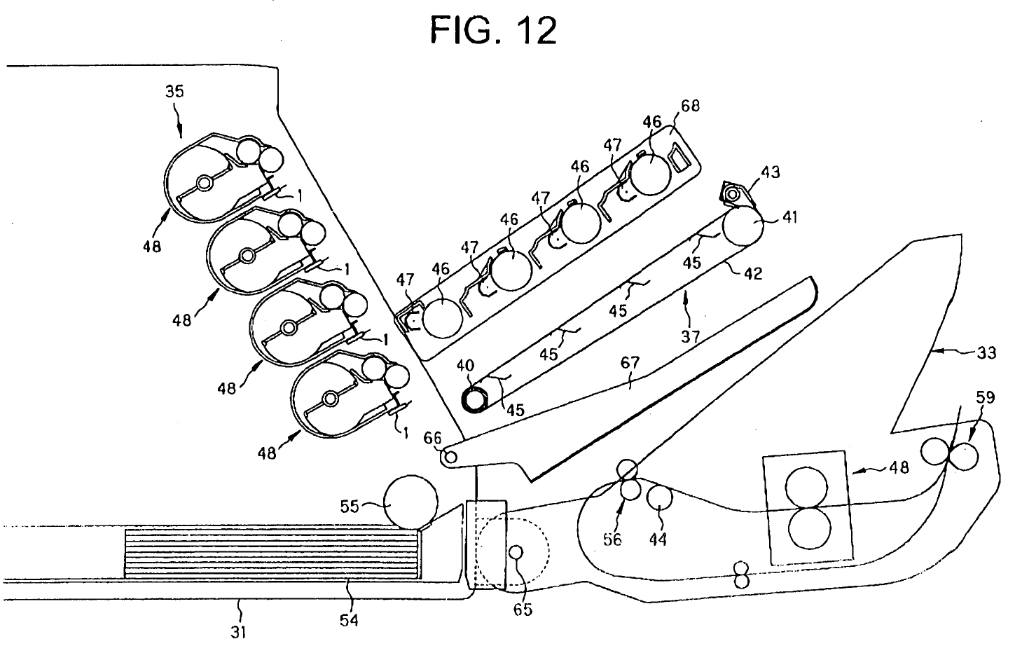

As shown in FIG. 12 through FIG. 14, since the fixing unit 58 is pivotally moved outside during replacement of consumables, the fixing unit 58 as a source of moisture can be spaced apart from the exposure heads 1 during the replacement of consumables such as the developing means 48 and the image carriers 46, thereby preventing adverse effect on the organic EL array exposure heads 1 due to the moisture and heat from the fixing unit 58 during the replacement of consumables.

The image carrier unit 68 can be detached from the housing body 31 by the movement in the radial direction of the image carriers 46, thereby eliminating the necessity for forming cutouts in the axial direction of the image carriers in the frame supporting the image carriers in order to avoid the interference.

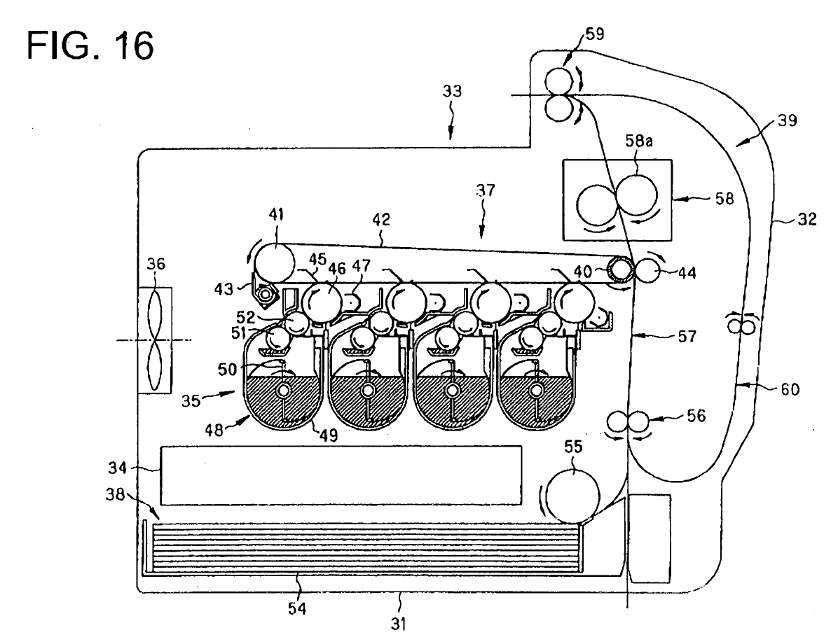

By the way, as types of arranging the image forming stations Y, M, C, K in tandem, there is a horizontal type in which these are horizontally arranged as shown in FIG. 16 besides the vertical type in which these are arranged vertically as shown in FIG. 1 and the oblique tandem type in which these are obliquely as shown in FIG. 7 and FIG. 9. This embodiment shown in FIG. 16 also has substantially the same structure of the embodiment of FIG. 1 so that the intermediate transfer belt 42 is disposed between the organic EL array exposure heads 1 and the fixing unit 58, thereby preventing the deterioration of the organic EL emitters of the organic EL array exposure heads 1 due to the moisture generated at the fixing unit 58.

The full color image forming apparatuses of tandem type as shown in FIG. 1, FIG. 7, FIG. 9, and FIG. 16 enable high-speed printing, but requiring four exposure means 48. By employing organic EL array exposure heads 1 as the exposure means, the reduction in size of the apparatus is effectively achieved.

Among them, the vertical tandem arrangement as shown in FIG. 1 realizes a small image forming apparatus requiring smaller area for installation because the direction of image forming process is vertical.

The oblique tandem arrangement as shown in FIG. 7 or FIG. 9, in which the intermediate transfer belt 42 or the sheet delivery belt 42′ is laid with certain tension obliquely from the vertical direction and the processing means are aligned along a lower side of the belt 42 or 42′, also realizes a small image forming apparatus requiring smaller area for installation because the intermediate transfer belt 42 or the sheet delivery belt 42′ is inclined so as to form a space for the fixing unit 58 at an upper corner section of the housing. In addition, the fixing unit 58 can be located at a position higher than the intermediate transfer belt 42 or the sheet delivery belt 42′ and the organic EL array exposure heads 1 can be located below the intermediate transfer belt 42 or the sheet delivery belt 42′ so that the exposure heads 1 are hardly affected by the heat from the fixing unit 58, thereby reducing vibration in temperature around the exposure heads 1.

On the other hand, the horizontal tandem arrangement as shown in FIG. 16 realizes a small image forming apparatus having lower height in the vertical direction.

The full color image forming apparatus of a tandem type may be designed such that four image carriers 46 are mounted to a common frame so that the image carriers 46 can be replaced together at once. In this case, only a single frame is used for photoreceptors (image carriers), making the frame construction simple and thus achieving the reduction in size. In addition, easy maintenance is achieved.

In case that the intermediate transfer belt 42 or the sheet delivery belt 42′ passes the lower side before passing a side where the exposure heads 1 are located in the image forming apparatus of vertical or oblique tandem type as show in FIG. 7, the intermediate transfer belt 42 or the sheet delivery belt 42′, warmed by the fixing unit 58, moves upward at the side where the exposure heads 1 are located so that the exposure heads 1 are warmed in order from the lowest one, thereby effectively heating the exposure heads 1 and further uniformly heating the four exposure heads 1. Therefore, the increase in temperature of the area surrounding the exposure heads 1 reduces the relative humidity around the exposure heads 1, thereby preventing the deterioration of the exposure heads 1 and also increasing the emitting efficiency of the exposure heads 1.

In the image forming apparatus, there are other heat sources, besides the fixing unit 58, including the electrical substrate 34 and driving motors for rotating the image carriers 46 and the intermediate transfer belt 42 or the sheet delivery belt 42′. Such a heat source is preferably located at a position lower than the organic EL array exposure heads 1 just like the embodiments shown in FIG. 1, FIG. 7, FIG. 9, FIG. 16. According to this arrangement, the heat source(s) (in any one of the cases shown the aforementioned drawings, the electrical substrate 34) heats the organic EL array exposure heads 1, thereby reducing the relative humidity around the exposure heads 1, thereby preventing the deterioration of the exposure heads 1. In addition, the increase in temperature of the exposure heads 1 increases the emitting efficiency of the exposure heads 1.

also increasing the emitting efficiency of the exposure heads 1.

Heat from the electrical substrate 34 and the driving motors which are inherently provided in the apparatus is utilized, thereby avoiding the necessary of exclusive heat source such as a heater.

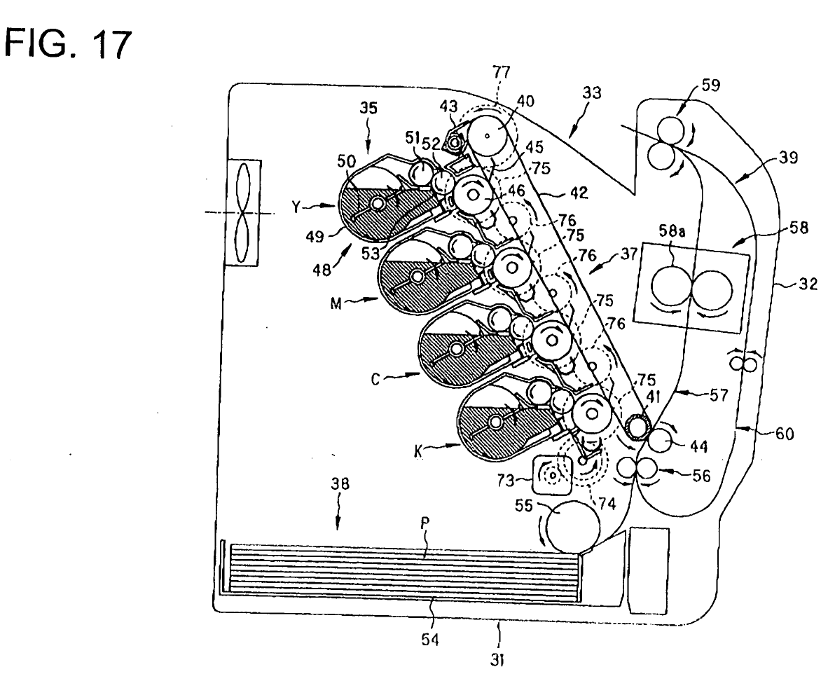

FIG. 17 is an illustration showing an embodiment similar to the embodiment shown in FIG. 9, except that a driving motor 73 as a heat source is located at a position lower than the organic EL array exposure heads 1 according to the present invention. The driving motor 73 drives a gear train, consisting of a combination gear 74 shown by dotted lines, photoreceptor driving gears 75, idle gears 76, and an intermediate transfer belt driving gear 77, so as to synchronize and rotate the image carriers 46 and the driving rollers 40. In this embodiment, the positions of the driving roller 40 and the tension roller 41 are changed to each other from the arrangement shown in FIG. 9.

Especially in the full color image forming apparatus of tandem type, by locating such heat sources behind the organic EL array exposure heads 1 (on a side of the exposure heads 1 opposite to the side where the intermediate transfer belt 42 or the sheet delivery belt is located), the problem due to uneven temperature among the exposure heads 1 can be solved. That is, if such heat sources are located at one side in the longitudinal direction of the exposure heads 1, only one sides in the longitudinal direction of the exposure heads 1 are heated, generating temperature distribution in the axial direction of the exposure heads 1 and thus generating unevenness in their emitting efficiency. In addition, when such a heat source is located at a position lower than the exposure heads 1, the temperatures of the exposure heads 1 become different according to the locations of the respective exposure heads 1, generating unevenness in their emitting efficiency. However, by locating such a heat source behind the exposure heads 1, the four exposure heads 1 can be heated uniformly in the longitudinal direction thereof, thereby preventing variation in deterioration among the exposure heads 1, preventing unevenness in their emitting efficiency, and preventing the registration error and unevenness of colors.

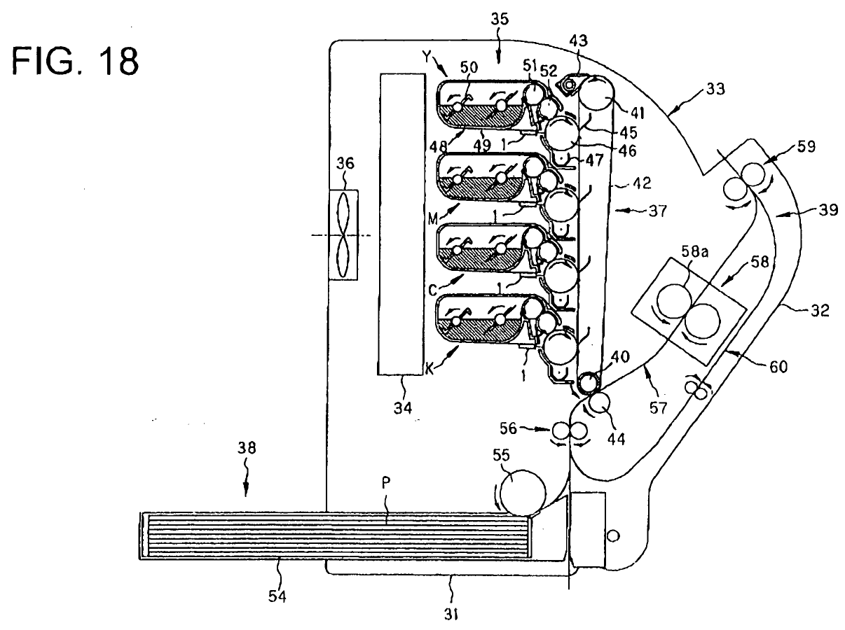

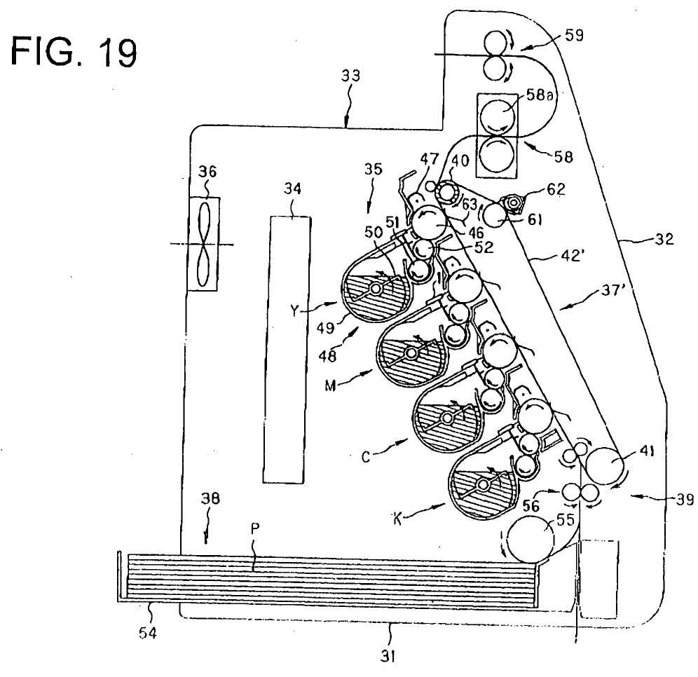

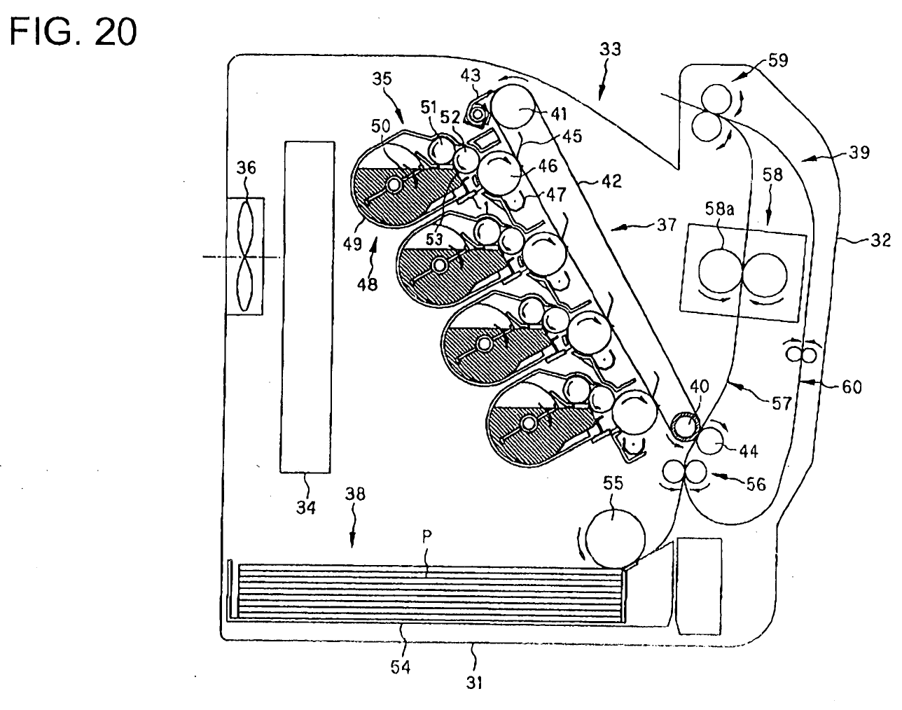

FIG. 18 shows an embodiment similar to the embodiment of FIG. 1 employing the vertical tandem arrangement and the intermediate transferring method, FIG. 19 shows an embodiment similar to the embodiment of FIG. 7 employing the oblique tandem arrangement and the sheet delivery method, and FIG. 20 shows an embodiment of FIG. 9 employing the oblique tandem arrangement and the intermediate transferring method. In any of these color image forming apparatus, the electrical substrate 34 as a heat source is located on a side of the image forming stations Y, M, C, K opposite to the side where the intermediate transfer belt 42 or the sheet delivery belt 42′. Other components are the same as those of FIG. 1, FIG. 7, and FIG. 9, respectively, so description will be omitted.

The heat source may be located at a position higher than the organic EL array exposure heads 1. By locating the heat source at a position higher than the organic EL array exposure heads 1, the exposure heads 1 can be prevented from being heated by the heat source. Especially in the full color image forming apparatus of tandem type, it is difficult to uniformly heat the four exposure heads 1 so that the exposure heads for different colors have sometimes different temperatures. Different temperatures lead to variation in pixel positions due to linear expansion and/or variation in emitting amounts, thereby producing registration error and unevenness of colors. The problem can be solved by locating the heat source at a position higher than the organic EL array exposure heads 1.

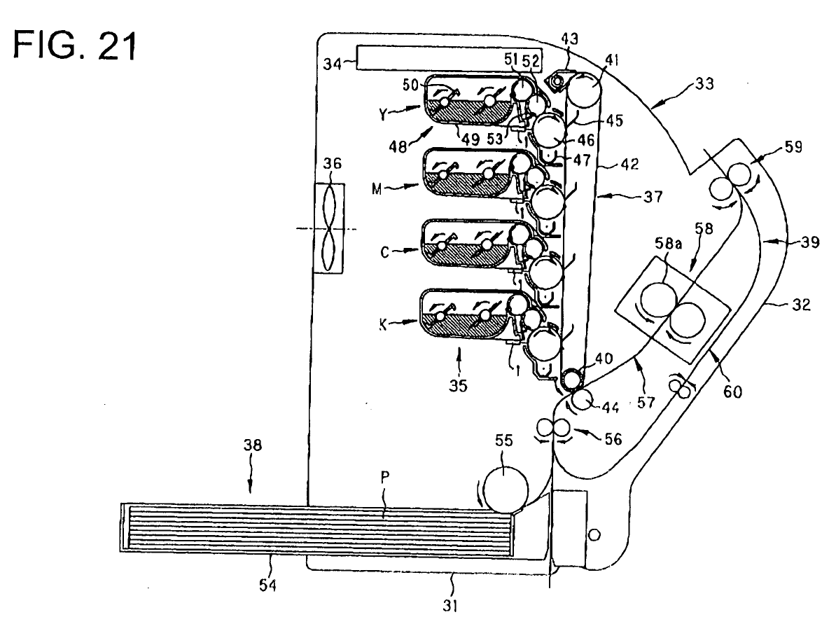

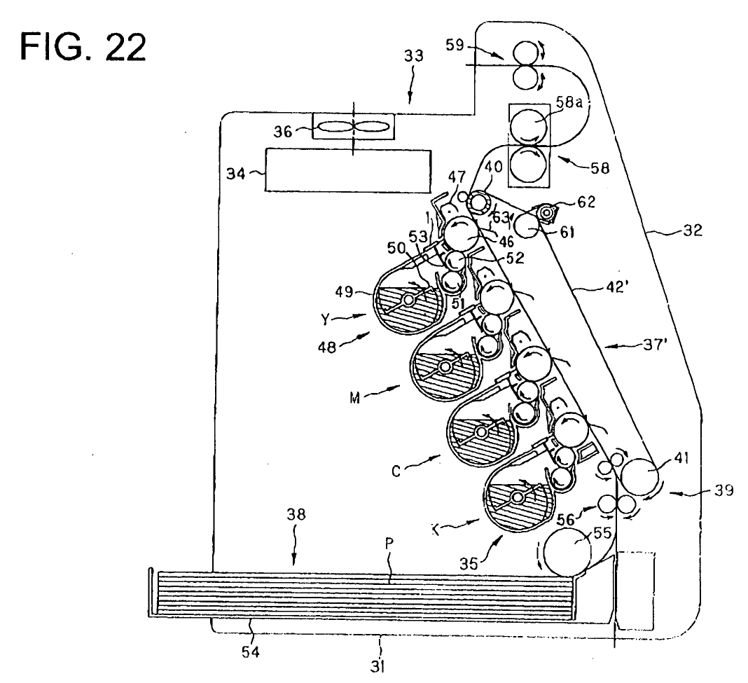

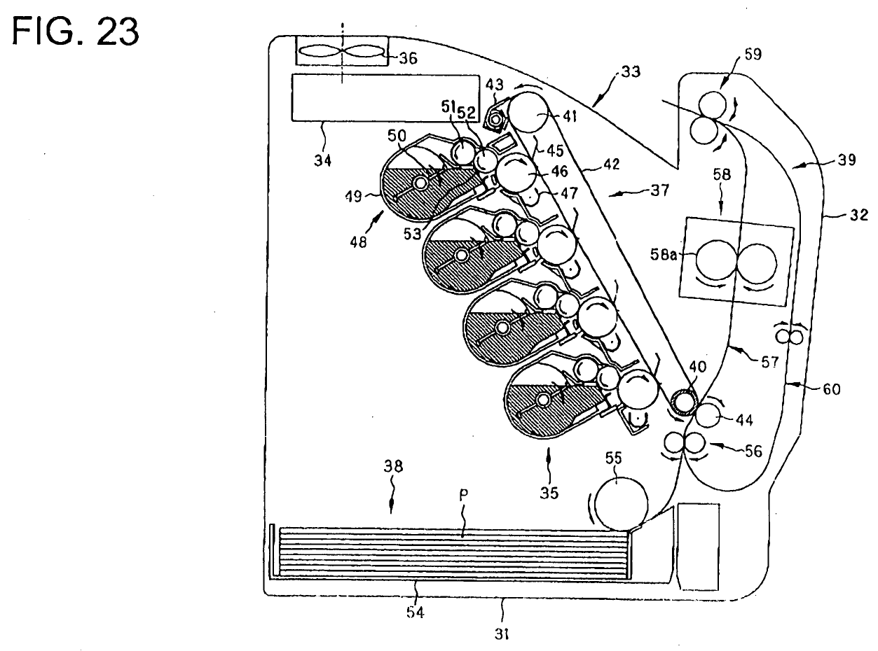

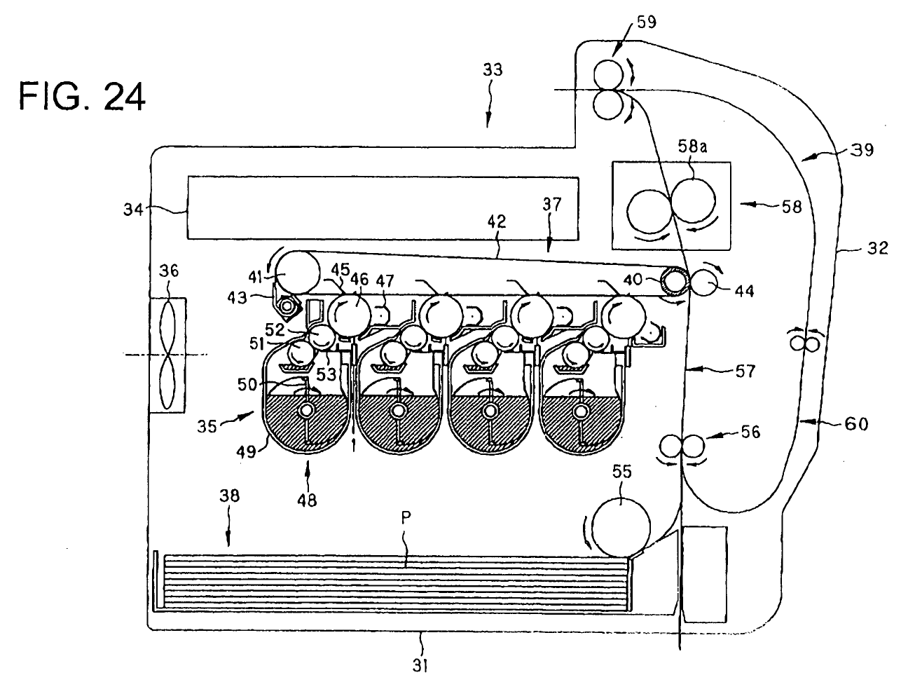

FIG. 21 shows an embodiment similar to the embodiment of FIG. 1 employing the vertical tandem arrangement and the intermediate transferring method, FIG. 22 shows an embodiment similar to the embodiment of FIG. 7 employing the oblique tandem arrangement and the sheet delivery method, FIG. 23 shows an embodiment of FIG. 9 employing the oblique tandem arrangement and the intermediate transferring method, FIG. 24 shows an embodiment similar to the embodiment of FIG. 16 employing the horizontal tandem arrangement and the intermediate transferring method. In any of these color image forming apparatus, the electrical substrate 34 as a heat source is located at a position higher than the image forming stations Y, M, C, K in the vertical direction. Other components are the same as those of FIG. 1, FIG. 7, FIG. 9, and FIG. 16, respectively, so description will be omitted.

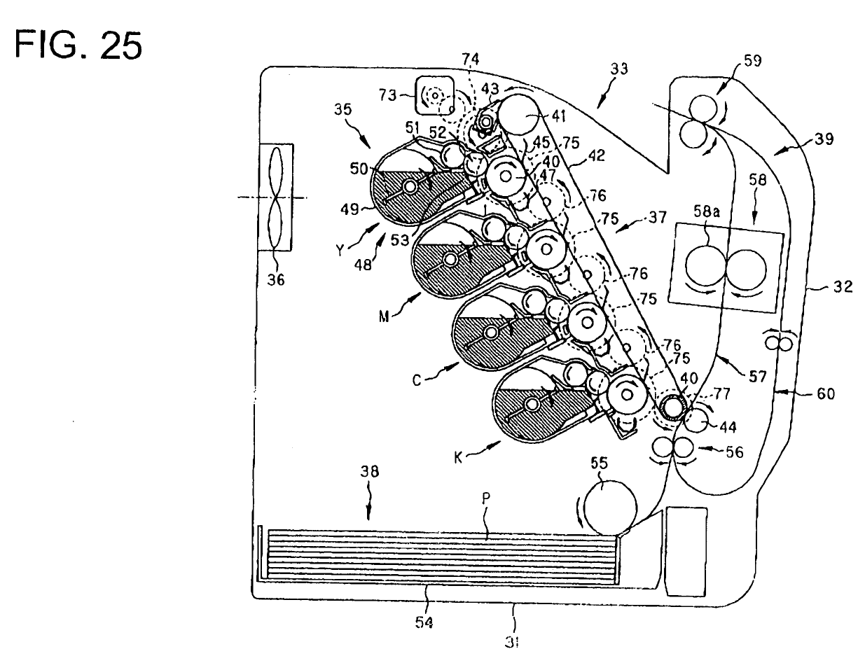

FIG. 25 is an illustration showing an embodiment similar to the embodiment shown in FIG. 9, except that a driving motor 73 as a heat source is located at a position higher than the organic EL array exposure heads 1 according to the present invention. The driving motor 73 drives a gear train, consisting of a combination gear 74 shown by dotted lines, photoreceptor driving gears 75, idle gears 76, and an intermediate transfer belt driving gear 77, so as to synchronize and rotate the image carriers 46 and the driving rollers 40. Other components are the same as those of FIG. 9, so description will be omitted.

In any of these embodiments, since the electrical substrate 34 or the driving motor 73 as a heat source is located at a position higher than the organic EL array exposure heads 1, the exposure heads 1 can be prevented from being heated by the heat source.

In the sense of preventing the organic EL array exposure heads 1 from being heated by heat source, it is preferable that the intermediate transfer belt 42 or the sheet delivery belt 42′ passes the upper side before passing a side where the exposure heads 1 are located in the image forming apparatus of vertical or oblique tandem type as show in FIG. 21, FIG. 23, and FIG. 25. That is, the intermediate transfer belt 42 or the sheet delivery belt 42′, heated by the fixing unit 58, moves downward at the side where the exposure heads 1 are located, thereby facilitating the heat release of the heated intermediate transfer belt 42 or the heated sheet delivery belt 42′ when passing the upper side and thus preventing the exposure heads 1 from being heated.

In this case, it is preferable that the intermediate transfer belt 42 or the sheet delivery belt 42′ has emissivity (=absorptivity) of nearly 0, preferably 0.2 or less. The decrease in emissivity of the intermediate transfer belt 42 or the sheet delivery belt 42′ reduces the transmission of heat from the fixing unit 58 by radiation to the intermediate transfer belt 42 or the sheet delivery belt 42′. As a result, the intermediate transfer belt 42 or the sheet delivery belt 42′ can be prevented from being heated, thus preventing the exposure heads 1 from being heated. As an example of a belt having low emissivity, a Ni electroforming tube belt (having emissivity of 0.05) may be employed.

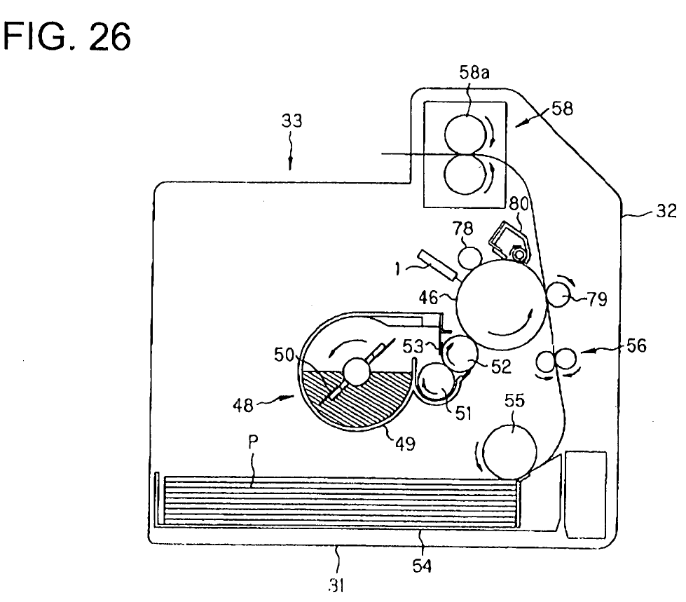

Also in an image forming apparatus employing an organic EL array exposure head 1 for developing, transferring, and fixing a unicolor toner image, by locating a fixing unit 58 at a position higher than the organic EL array exposure head 1 in the vertical direction as shown in FIG. 26, hot air with high humidity generated at the fixing unit 58 moves upward to a position above the fixing unit by convection so that air having high moisture never moves to the neighborhood of the organic EL array exposure head 1. Accordingly, the fixing unit 58 can be located near the exposure head 1 so as to achieve the transmission of heat from the fixing unit 58 by radiation to the exposure head 1, thereby heating the exposure head 1 to increase its emitting efficiency.

In FIG. 26, the outer surface of an image carrier (photosensitive drum) 46 rotating in a direction of arrow is uniformly charged by a charging roller 78 and is then exposed to light by the organic EL array exposure head 1 so as to form an electrostatic latent image. The electrostatic latent image is developed by a developing means 48 into a toner image. A transfer bias is applied to a transfer roller 79, whereby the toner image is transferred to a receiving medium P supplied from a sheet cassette 54. The toner image is fixed on the receiving medium P by passing between a pair of fixing rollers 58a of the fixing unit 58. The receiving medium P with the image is discharged to an outfeed tray 33 formed in the top of the apparatus. The residual toner on the image carrier (photosensitive drum) 46 is removed by a cleaner 80.

Though the image forming apparatus of the present invention has been described with reference to the embodiments disclosed herein, the present invention is not limited thereto and various changes may be made therein.

As apparent from the above description, in an image forming apparatus of the first aspect of the present invention, an intermediate transfer belt or a sheet delivery belt is located between an organic EL array exposure head and a fixing means. By heating a receiving medium (paper sheet) at the fixing means, the moisture contained in the paper sheet is vaporized to produce hot air with high humidity. However, the hot air with high humidity is blocked by the intermediate transfer belt or the sheet delivery belt, thereby preventing the deterioration of organic EL emitters of the organic EL array exposure head due to the moisture generated at the fixing unit.

In an image forming apparatus of the second aspect of the present invention, an organic EL array exposure head is provided as the exposure means and at least one heat source of the apparatus is located at a position lower than the organic EL array exposure head. The organic EL array exposure head is heated by the heat source so as to reduce the relative humidity around the exposure heads, thereby preventing the deterioration of organic EL emitters of the organic EL array exposure head due to the moisture. In addition, the increase in temperature of organic EL emitters because of the heat source increases the emitting efficiency of the exposure head.

In an image forming apparatus of the third aspect of the present invention, an organic EL array exposure head is provided as the exposure means and at least one heat source of the apparatus is located at a rear side of the organic EL array exposure head opposite to a side where said transfer means is located, thereby preventing variation in deterioration among the exposure heads, preventing unevenness in their emitting efficiency, and preventing the registration error and unevenness of colors.

In an image forming apparatus of the fourth aspect of the present invention, an organic EL array exposure head is provided as the exposure means and at least one heat source of the apparatus is located at a position higher than the organic EL array exposure head so that the organic EL array exposure head can be prevented from being heated by the heat source, thereby preventing variation in deterioration among the exposure heads, preventing unevenness in their emitting efficiency, and preventing the registration error and unevenness of colors.

What we claim is:

1. An image forming apparatus comprising at least one image forming station having an image carrier and further having a charging means, an exposure means, a developing means, and a transfer means which are arranged around said image carrier, wherein a toner image formed by said image forming station is transferred to a transfer medium;
said exposure means comprises an organic EL array exposure head;
said transfer medium is an intermediate transfer belt or a receiving medium carried by a sheet delivery belt;
said image forming apparatus further comprises a fixing means for fixing the toner image on a receiving medium secondarily transferred from said intermediate transfer belt or fixing the toner image on the receiving medium separated from said sheet delivery belt; and
said intermediate transfer belt or said sheet delivery belt is located between said organic EL array exposure head and said fixing means.

2. An image forming apparatus comprising at least one image forming station having an image carrier and further having a charging means, an exposure means, a developing means, and a transfer means which are arranged around said image carrier, wherein a toner image formed by said image forming station is transferred to a transfer medium;
said exposure means comprises an organic EL array exposure head; and
at least one heat source in the apparatus is located at a position lower than said organic EL array exposure head.

3. An image forming apparatus comprising at least one image forming station having an image carrier and further having a charging means, an exposure means, a developing means, and a transfer means which are arranged around said image carrier, wherein a toner image to formed by said image forming station is transferred to a transfer medium;
said exposure means comprises an organic EL array exposure head; and
at least one heat source in the apparatus is located at a rear side of said organic EL array exposure head opposite to a side where said transfer means is located.

4. An image forming apparatus comprising at least one image forming station having an image carrier and further having a charging means, an exposure means, a developing means, and a transfer means which are arranged around said image carrier, wherein a toner image formed by said image forming station is transferred to a transfer medium;
said exposure means comprises an organic EL array exposure head; and
at least one heat source in the apparatus is located at a position higher than said organic EL array exposure head.

5. An image forming apparatus as claimed in any one of claims 1 through 4, wherein emitters of said organic EL array exposure head are formed on a single substrate.

6. An image forming apparatus as claimed in any one of claims 1 through 4, wherein emitters said organic EL array exposure head and driving circuits for driving said emitters are formed on a single substrate.

7. An image forming apparatus as claimed in any one of claims 1 through 4, wherein emitters said organic EL array exposure head and driving circuits for driving said emitters are formed on a single substrate, and a thin-film transistor is employed as each of said driving circuits.

8. An image forming apparatus as claimed in any one of claims 1 through 4, wherein emitters of said organic EL array exposure head are driven by a constant current control.

9. An image forming apparatus as claimed in any one of claims 1 through 3, wherein said fixing means is located at a position higher than said organic EL array exposure head.

10. An image forming apparatus as claimed in any one of claims 1 through 4, wherein said intermediate transfer belt or said sheet delivery belt is made of a resin.

11. An image forming apparatus as claimed in any one of claims 1 through 4, wherein said intermediate transfer belt or said sheet delivery belt is made of a water-absorbing material.

12. An image forming apparatus as claimed in any one of claims 1 through 4, wherein said image forming apparatus employs the intermediate transfer method utilizing said intermediate transfer belt.

13. An image forming apparatus as claimed in any one of claims 1 through 4, wherein said image forming apparatus employs the sheet delivery method utilizing said sheet delivery belt.

14. An image forming apparatus as claimed in any one of claims 1 through 4, wherein the number of said image forming stations is two or more and said image forming stations are arranged in tandem.

15. An image forming apparatus as claimed in any one of claims 1 through 4, wherein the number of said image forming stations is one and said developing means is a rotary developing device comprising a plurality of developing units which are arranged about the rotation axis such a manner as to allow angular switching operation.

16. An image forming apparatus as claimed in any one of claims 1 through 4, wherein the number of said image forming stations is two or more, said image forming stations are arranged in tandem, and said image forming apparatus employs a vertical arrangement in which said intermediate transfer belt or said sheet delivery belt runs in substantially the vertical direction.

17. An image forming apparatus as claimed in any one of claims 1 through 4, wherein the number of said image forming stations is two or more, said image forming stations are arranged in tandem, and said image forming apparatus employs an oblique arrangement in which said intermediate transfer belt or said sheet delivery belt runs in an oblique direction.

18. An image forming apparatus as claimed in any one of claims 1 through 4, wherein the number of said image forming stations is two or more, said image forming stations are arranged in tandem, and said image forming apparatus employs a horizontal arrangement in which said intermediate transfer belt or said sheet delivery belt runs in substantially the horizontal direction.

19. An image forming apparatus as claimed in any one of claims 1 through 4, wherein the number of said image forming stations is one, said developing means is a rotary developing device comprising a plurality of developing units which are arranged about the rotation axis such a manner as to allow angular switching operation, and said image forming apparatus employs a vertical arrangement in which said intermediate transfer belt or said sheet delivery belt runs in substantially the vertical direction.

20. An image forming apparatus as claimed in any one of claims 1 through 4, wherein the number of said image forming stations is one, said developing means is a rotary developing device comprising a plurality of developing units which are arranged about the rotation axis such a manner as to allow angular switching operation, and said image forming apparatus employs an oblique arrangement in which said intermediate transfer belt or said sheet delivery belt runs in an oblique direction.

21. An image forming apparatus as claimed in any one of claims 1 through 4, wherein the number of said image forming stations is one, said developing means is a rotary developing device comprising a plurality of developing units which are arranged about the rotation axis such a manner as to allow angular switching operation, and said image forming apparatus employs a horizontal arrangement in which said intermediate transfer belt or said sheet delivery belt runs in substantially the horizontal direction.

22. An image forming apparatus as claimed in any one of claims 1 through 4, wherein said intermediate transfer belt or the sheet delivery belt is laid around two rollers with a certain tension.

23. An image forming apparatus as claimed in any one of claims 1 through 4, wherein the number of said image forming stations is two or more and said image forming stations are arranged in tandem, and a plurality of image carriers are attached to a common frame so as to allow all of said image carriers to be replaced as a single unit.

24. An image forming apparatus as claimed in any one of claims 1 through 4, wherein said organic EL array exposure head is positioned relative to said image carrier.

25. An image forming apparatus as claimed in any one of claims 1 through 4, wherein said fixing means is displaced about a pivot shaft for replacement of consumables.

26. An image forming apparatus as claimed in any one of claims 1 through 4, wherein said fixing means is displaced about a pivot shaft for replacement of consumables, and said image carriers become detachable relative to the apparatus body according to said pivotal displacement of said fixing means.

27. An image forming apparatus as claimed in any one of claims 1 through 4, wherein said image forming apparatus is designed to allow the replacement of consumables at one side thereof.

28. An image forming apparatus as claimed in any one of claims 1 through 4, wherein the number of said image forming stations is two or more, said image forming stations are arranged in tandem, said image forming apparatus employs a vertical arrangement in which said intermediate transfer belt or said sheet delivery belt runs in substantially the vertical direction, and said intermediate transfer belt or said sheet delivery belt passes the lower side before passing a side where said organic EL array exposure head is located.

29. An image forming apparatus as claimed in any one of claims 1 through 4, wherein the number of said image forming stations is one, said developing means is a rotary developing device comprising a plurality of developing units which are arranged about the rotation axis such a manner as to allow angular switching operation, said image forming apparatus employs a vertical arrangement in which said intermediate transfer belt or said sheet delivery belt runs in substantially the vertical direction, and said intermediate transfer belt or said sheet delivery belt passes the lower side before passing a side where said organic EL array exposure head is located.

30. An image forming apparatus as claimed in any one of claims 1 through 4, wherein said intermediate transfer belt or said sheet delivery belt is made of a material having emissivity (=absorptivity) of about 0.8 or more.

31. An image forming apparatus as claimed in any one of claims 2 through 4, wherein said heat source is an electrical substrate for driving and controlling the apparatus.

32. An image forming apparatus as claimed in any one of claims 2 through 4, wherein said heat source is a motor for driving a movable member of the apparatus.

33. An image forming apparatus as claimed in any one of claims 2 through 4, wherein
said transfer medium is an intermediate transfer belt or a receiving medium carried by a sheet delivery belt;
said image forming apparatus further comprises a fixing means for fixing the toner image on a receiving medium secondarily transferred from said intermediate transfer belt or fixing the toner image on the receiving medium separated from said sheet delivery belt; and
said intermediate transfer belt or said sheet delivery belt is located between said organic EL array exposure head and said fixing means.

34. An image forming apparatus as claimed in claim 4, wherein said heat source is a fixing means for fixing the toner image on a receiving medium to said receiving medium.

35. An image forming apparatus as claimed in claim 4, wherein the number of said image forming stations is two or more, said image forming stations are arranged in tandem, and said intermediate transfer belt or said sheet delivery belt passes the upper side before passing a side where said organic EL array exposure head is located.

36. An image forming apparatus as claimed in claim 4, wherein the number of said image forming stations is one, said developing means is a rotary developing device comprising a plurality of developing units which are arranged about the rotation axis such a manner as to allow angular switching operation, and said intermediate transfer belt or said sheet delivery belt passes the upper side before passing a side where said organic EL array exposure head is located.
